(19) United States
(12) Patent Application Publication
(10) Pub. No.: US 2024/0325807 A1
(43) Pub. Date: Oct. 3, 2024

(54) FIRE MONITORING APPARATUS AND METHOD

(71) Applicant: LG ENERGY SOLUTION, LTD., Seoul (KR)

(72) Inventors: Hyun-Min LEE, Daejeon (KR); Yo-Hwan KIM, Daejeon (KR); Kyung-Min LEE, Daejeon (KR); Ji-Won LEE, Daejeon (KR); Jong-Min PARK, Daejeon (KR); Jong-Soo LEE, Daejeon (KR)

(73) Assignee: LG ENERGY SOLUTION, LTD., Seoul (KR)

(21) Appl. No.: 18/580,042

(22) PCT Filed: Jan. 19, 2023
(86) PCT No.: PCT/KR2023/000989

§ 371 Date: Jan. 17, 2024

(30) Foreign Application Priority Data
Jan. 19, 2022 (KR) 10-2022-0008139

(51) Int. Cl. A62C 37/38; A62C 3/16; A62C 35/02; A62C 35/58; A62C 99/00

(52) U.S. Cl. CPC A62C 37/38; A62C 3/16; A62C 35/023; A62C 35/58; A62C 99/009

(57) ABSTRACT

A fire monitoring apparatus according to an embodiment of the present disclosure is a device for monitoring a fire in an energy storage system, and includes a fire level determination unit for receiving a smoke detection signal from a smoke sensor provided inside the energy storage system and determining a fire level according to the number of smoke sensors that detect the smoke, a control unit for controlling an operation of at least one of an air conditioning unit, a fire extinguishing unit, a watering unit and a ventilation unit for the energy storage system as a fire suppression measure corresponding to the determined fire level.

### CROSS-REFERENCE TO RELATED APPLICATIONS

The present application claims priority to Korean Patent Application No. 10-2022-0008139 filed on Jan. 19, 2022 in the Republic of Korea, the disclosures of which are incorporated herein by reference.

### BACKGROUND OF THE DISCLOSURE

### Technical Field

The present disclosure relates to a fire monitoring apparatus and method, and more particularly, to a fire monitoring apparatus and method capable of monitoring whether or not a fire occurs in a battery and taking related measures when a fire occurs to extinguish the fire.

### Description of Related Art

Recently, the demand for portable electronic products such as notebook computers, video cameras and portable telephones has increased sharply, and electric vehicles, energy storage batteries, robots, satellites and the like have been developed in earnest. Accordingly, high-performance batteries allowing repeated charging and discharging are being actively studied.

Batteries commercially available at present include nickel-cadmium batteries, nickel hydrogen batteries, nickel-zinc batteries, lithium batteries and the like. Among them, the lithium batteries are in the limelight since they have almost no memory effect compared to nickel-based batteries and also have very low self-discharging rate and high energy density.

On the other hand, since these batteries have a disadvantage of being vulnerable to external surges and high temperatures, an energy storage system (ESS) that intensively stores batteries has a problem in that the risk of fire always exists.

In general, a fire in an energy storage system starts ignition in an individual battery cell unit, and then the fire can develop in a (entire) battery rack unit. In this case, since the fire generated in a battery cell unit can spread to the entire energy storage system, it is necessary to monitor whether a fire occurs and take a corresponding measure promptly in the early stage of a fire.

### SUMMARY OF THE DISCLOSURE

### Technical Problem

The present disclosure is designed to solve the problems of the related art, and therefore the present disclosure is directed to providing a fire monitoring apparatus and method capable of monitoring a fire inside an energy storage system and extinguishing the fire at an early stage.

These and other objects and advantages of the present disclosure can be understood from the following detailed description and will become more fully apparent from the exemplary embodiments of the present disclosure. Also, it will be easily understood that the objects and advantages of the present disclosure can be realized by the means shown in the appended claims and combinations thereof.

### Technical Solution

A fire monitoring apparatus according to one aspect of the present disclosure can be a device for monitoring a fire in an energy storage system equipped with a plurality of battery modules.

The fire monitoring apparatus can comprise a fire level determination unit configured to receive a smoke detection signal from a smoke sensor provided inside the energy storage system and determine a fire level according to the number of smoke sensors that detect the smoke; and a control unit configured to control an operation of at least one of an air conditioning unit, a fire extinguishing unit, a watering unit and a ventilation unit for the energy storage system as a fire suppression measure corresponding to the determined fire level.

The fire level determination unit can be configured to determine the fire level as a first level when the smoke is detected in only one of the plurality of smoke sensors.

The fire level determination unit can be configured to determine the fire level as a second level when the smoke is detected in several smoke sensors among the plurality of smoke sensors.

The control unit can be configured to stop the operation of the air conditioning unit provided inside the energy storage system when the fire level is determined as the first level or the second level.

When the fire level is determined as the second level, the control unit can be configured to operate the fire extinguishing unit provided inside the energy storage system, so that a fire extinguishing agent contained inside the fire extinguishing unit is injected into the energy storage system.

The watering unit can be configured to be connected to each battery module included in the energy storage system through a pipeline equipped with a bulb that is capable of being destroyed according to a temperature of the corresponding battery module.

The control unit can be configured to introduce the fire extinguishing fluid provided in the watering unit into the pipeline by operating the watering unit, when the fire level is determined as the second level.

The fire extinguishing fluid can be introduced into the pipeline by the watering unit and introduced into a battery module at which the bulb of the corresponding pipeline is destroyed among the plurality of battery modules.

The control unit can be configured to determine a water level of the fire extinguishing fluid provided in the watering unit, and operate the ventilation unit to ventilate the energy storage system with an external air when the determined water level is equal to or lower than a preset critical water level.

The control unit can be configured to determine a water level of the fire extinguishing fluid provided in the watering unit, judge that a battery fire occurs in the energy storage system when the determined water level is equal to or lower than a preset critical water level, and judge that an electrical fire occurs in the energy storage system when the determined water level exceeds the critical water level.

The control unit can be configured to receive a measured gas concentration from a gas sensor provided in the energy storage system, stop the operation of the air conditioning unit provided inside the energy storage system when the measured gas concentration is equal to or greater than a preset critical concentration, and operate the ventilation unit to ventilate the energy storage system with an external air.

A fire monitoring system according to another aspect of the present disclosure can comprise the fire monitoring apparatus according to one aspect of the present disclosure and an energy storage system.

A fire monitoring method according to still another aspect of the present disclosure can be a method for monitoring a fire in an energy storage system equipped with a plurality of battery modules.

The fire monitoring method can comprise a smoke detection signal receiving step of receiving a smoke detection signal from a smoke sensor provided inside the energy storage system; a fire level determining step of determining a fire level according to the number of smoke sensors that detect the smoke, when the smoke is detected; and a fire controlling step of controlling an operation of at least one of an air conditioning unit, a fire extinguishing unit, a watering unit and a ventilation unit for the energy storage system as a fire suppression measure corresponding to the determined fire level.

The fire monitoring method can further comprise, in parallel to the smoke detection signal receiving step, a ventilation controlling step of receiving a measured gas concentration from a gas sensor provided in the energy storage system, and controlling the operation of the air conditioning unit and the ventilation unit according to a result of comparing the measured gas concentration with a preset critical concentration.

### Advantageous Effects

According to one aspect of the present disclosure, there is an advantage in that a fire occurrence level is determined based on smoke generated inside the energy storage system, and an appropriate fire suppression measure can be performed according to the determined fire occurrence level. Therefore, even if a fire occurs inside the energy storage system, the fire can be extinguished at an early stage.

In addition, according to one aspect of the present disclosure, a fire suppression measure can be performed based on the measured concentration of gas included in the energy storage system. Therefore, an accident, such as an explosion of the energy storage system, can be prevented in advance.

The effects of the present disclosure are not limited to the above, and other effects not mentioned herein will be clearly understood by those skilled in the art from the appended claims.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram schematically showing a fire monitoring apparatus according to an embodiment of the present disclosure.

FIG. 2 is a diagram schematically showing a fire monitoring system according to another embodiment of the present disclosure.

FIG. 3 is a diagram schematically showing a fire monitoring method according to still another embodiment of the present disclosure.

FIG. 4 is a diagram showing the fire monitoring method of FIG. 3 in more detail.

FIG. 5 is a diagram schematically showing a fire monitoring method according to still another embodiment of the present disclosure.

### DETAILED DESCRIPTION OF THE EMBODIMENTS

It should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

Additionally, in describing the present disclosure, when it is deemed that a detailed description of relevant known elements or functions renders the key subject matter of the present disclosure ambiguous, the detailed description is omitted herein.

The terms including the ordinal number such as “first”, “second” and the like, can be used to distinguish one element from another among various elements, but not intended to limit the elements by the terms.

Throughout the specification, when a portion is referred to as “comprising” or “including” any element, it means that the portion can include other elements further, without excluding other elements, unless specifically stated otherwise.

In addition, throughout the specification, when a portion is referred to as being “connected” to another portion, it is not limited to the case that they are “directly connected”, but it also includes the case where they are “indirectly connected” with another element being interposed between them.

Hereinafter, a preferred embodiment of the present disclosure will be described in detail with reference to the accompanying drawings.

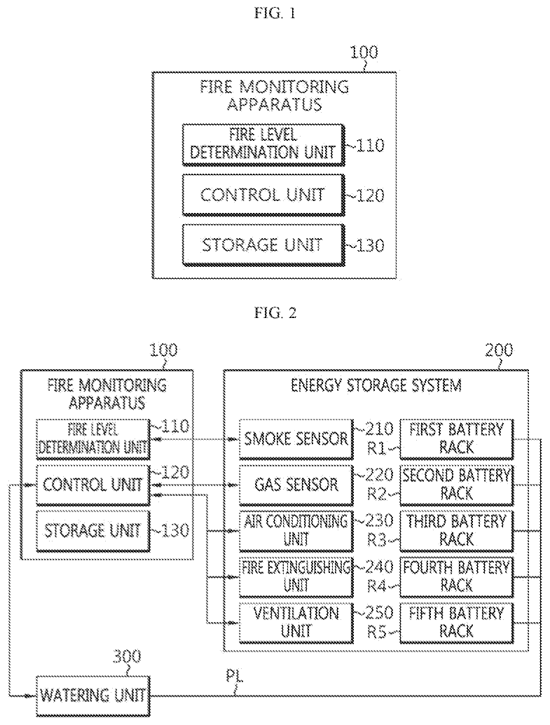

FIG. 1 is a diagram schematically showing a fire monitoring apparatus 100 according to an embodiment of the present disclosure. FIG. 2 is a diagram schematically showing a fire monitoring system according to another embodiment of the present disclosure.

A fire monitoring apparatus 100 according to an embodiment of the present disclosure can be a device for monitoring a fire in an energy storage system 200 equipped with a plurality of battery modules, where each battery module can include a plurality of battery cells.

First, referring to FIG. 2, a fire monitoring system can include a fire monitoring apparatus 100, an energy storage system 200, and a watering unit 300. In the non-limiting embodiment of FIG. 2, a watering unit 300 is shown outside the fire monitoring apparatus 100 and the energy storage system 200, but it should be noted that the watering unit 300 can be provided inside the energy storage system 200.

The energy storage system 200 can include a plurality of battery racks R1 to R5, a smoke sensor 210, a gas sensor 220, an air conditioning unit 230, a fire extinguishing unit 240, and a ventilation unit 250.

The plurality of battery racks R1 to R5 can be a cell assembly included in the energy storage system 200.

For example, the battery rack can be formed in a frame structure in which battery modules can be seated. Each battery rack can include a plurality of battery modules. Also, each battery module can include a plurality of battery cells.

Here, the battery cell refers to a physically separable independent cell having a negative electrode terminal and a positive electrode terminal. As an example, a lithium-ion battery or a lithium polymer battery can be considered a battery cell, but the present application is not limited thereto, and any type of battery cells can be used. In the non-limiting embodiment of FIG. 2, an embodiment in which five battery racks R1 to R5 are provided in the energy storage system 200 is shown, but it should be noted that the number of battery racks that can be included in the energy storage system 200 is not limited.

The smoke sensor 210 is a sensor capable of detecting smoke generated inside the energy storage system 200. Preferably, a plurality of smoke sensors 210 can be provided inside the energy storage system 200. The smoke sensor can be an ionization type smoke sensor that works by sending a small electrical current through a chamber of air, when smoke enters the chamber, it disrupts the flow of current and triggers the alarm, a photoelectric smoke sensor that works by shining a beam of light onto a sensor and when smoke particles enter the beam, they scatter the light and trigger the alarm, or a combination of ionization and photoelectric technologies, but is not limited thereto.

The gas sensor 220 is a sensor capable of detecting gas generated inside the energy storage system 200. The gas sensor can be an ionization sensor, a semiconductor sensor or a membrane sensor, but is not limited thereto. For example, the gas sensor 220 can detect H².

The air conditioning unit 230 can be provided inside the energy storage system 200. Also, the air conditioning unit 230 can be configured to circulate the internal air of the energy storage system 200. That is, the air conditioning unit 230 can lower the temperature of the internal air through heat exchange between the internal air of the energy storage system 200 and the external air, and circulate the internal air having a lowered temperature. For example, a HVAC (Heating, Ventilation and Air Conditioning) can be applied to the air conditioning unit 230.

The fire extinguishing unit 240 can be provided inside the energy storage system 200. Also, when the fire extinguishing unit 240 is operated, the fire extinguishing agent stored in the fire extinguishing unit 240 can be sprayed into the energy storage system 200. For example, NOVEC 1230 can be applied to the fire extinguishing unit 240. However, any type of fire extinguishing liquid/gas can be used.

The ventilation unit 250 can be provided in the energy storage system 200. When the ventilation unit 250 is operated, an external air can be introduced into the energy storage system 200. That is, the ventilation unit 250 can be configured to ventilate the energy storage system 200. For example, an active ventilation system (AVS) can be applied to the ventilation unit 250.

The watering unit 300 can be configured to store the fire extinguishing fluid. In addition, the watering unit 300 can be configured to be connected to each battery module included in the energy storage system 200 through a pipeline PL equipped with a bulb that can be destroyed depending on the temperature of the corresponding battery module. For example, the pipeline PL can be respectively connected to a plurality of battery modules included in each battery rack.

In addition, at least one bulb can be provided at the end of the pipeline PL connected to the battery module. A plurality of bulbs can be provided, each bulb being located adjacent to a respective battery rack among the plurality of battery racks R1-R5. Here, the breakable bulb (e.g., temperature device) can be provided in the pipeline PL, for example, to seal the pipeline (i.e., pipe or tube). That is, the breakable bulb can be thermostatic expansion valve (TXV), which is a temperature-controlled valve that is used in hot water heating systems and has a sensing bulb that is filled with a liquid that expands and contracts with temperature changes. When the water temperature reaches a certain point, the liquid in the sensing bulb expands and opens the valve, allowing more water to flow to the coils. This keeps the water temperature at a constant level. The bulb can be destroyed if the temperature of the corresponding battery module rises to a certain temperature or above. That is, when the watering unit 300 is operated and the fire extinguishing fluid is introduced into the pipeline PL, the fire extinguishing fluid can be ejected into the corresponding battery module through the pipeline PI, where the bulb is destroyed. That is, when the temperature of the battery rack or battery module reaches a predetermined temperature (i.e., too high of a temperature), the bulb can be designed to break, thereby allowing water or other fire extinguishing liquid to flow from the fire extinguishing unit 240 to the energy storage system 200. In other words, the fire extinguishing fluid can be introduced into the pipeline PL by the watering unit 300, and can be introduced into the battery module in which the bulb of the corresponding pipeline PL is destroyed among the plurality of battery modules. For example, a fire extinguishing fluid can be applied without limitation as long as it is for extinguishing a fire generated in a battery module. In one embodiment, the fire extinguishing fluid can be water.

Referring to FIG. 1, the fire monitoring apparatus 100 can include a fire level determination unit 110 and a control unit 120.

The fire level determination unit 110 can be configured to receive a smoke detection signal from the smoke sensor 210 provided inside the energy storage system 200.

Specifically, the fire level determination unit 110 can be connected to the smoke sensor 210 provided inside the energy storage system 200 through wired and/or wireless communication.

Hereinafter, it is assumed that a plurality of smoke sensors 210 are provided inside the energy storage system 200. The fire level determination unit 110 can be connected to each of the plurality of smoke sensors 210 and receive a smoke detection signal from each smoke sensor 210. The plurality of smoke sensors 210 can be spaced apart from one another.

The fire level determination unit 110 can be configured to determine a fire level (i.e., a fire amount) according to the number of smoke sensors 210 that detect smoke.

Specifically, when smoke is detected in only one of the plurality of smoke sensors 210, the fire level determination unit 110 can be configured to determine the fire level as a first level. Conversely, when smoke is detected in several smoke sensors among the plurality of smoke sensors 210, the fire level determination unit 110 can be configured to determine the fire level as a second level.

For example, the fire level determination unit 110 can receive a smoke detection signal from the smoke sensor 210 that detects smoke generated inside the energy storage system 200. Since the fire level determination unit 110 is connected to each of the plurality of smoke sensors 210, it is possible to determine the number of smoke detection signals received from each smoke sensor 210. Accordingly, the fire level determination unit 110 can determine the fire level as a first level or a second level according to the number of received smoke detection signals.

The control unit 120 can be configured to control the operation of at least one of the air conditioning unit 230, the fire extinguishing unit 240, the watering unit 300, and the ventilation unit 250 for the energy storage system 200 as a fire suppression measure corresponding to the determined fire level.

Specifically, the control unit 120 can perform a fire suppression measure corresponding to the determined fire level. That is, the fire suppression measure performed when the fire level is the first level and the fire suppression measure performed when the fire level is the second level can be partially different.

Different fire suppression measures according to the fire level can be derived from the number of smoke sensors 210 that detect smoke. When the fire extinguishing agent is injected or the fire extinguishing fluid is introduced into the battery module, the corresponding battery module and/or the battery module provided in the energy storage system 200 may not be reusable. Therefore, it is desirable that the fire suppression measure is performed after accurately determining whether a fire has actually occurred in the energy storage system 200.

For example, in general, the energy storage system 200 is sealed from the outside, and the internal air is circulated by the air conditioning unit 230. In this case, if smoke is detected by only one smoke sensor 210, the possibility of a sensing error in the smoke sensor 210 detecting smoke can be greater than the possibility that smoke is generated due to a fire. Conversely, if smoke is detected by a plurality of smoke sensors 210, the possibility that smoke is generated due to a fire can be greater than the possibility that the plurality of smoke sensors 210 have sensing errors. Accordingly, the control unit 120 can be configured to perform a fire suppression measure according to the fire level determined based on the number of smoke sensors 210 that detect smoke.

Therefore, the fire monitoring apparatus 100 according to an embodiment of the present disclosure can monitor whether a fire occurs in the energy storage system 200 in consideration of the possibility of a sensing error of the smoke sensor 210, and take an appropriate fire suppression measure to correspond to the monitoring result. For example, in the case of a sensing error of the smoke sensor 210, there is an advantage in that the energy storage system 200 can be protected by performing only a minimal measure. Conversely, in the case where a fire occurs, there is an advantage in that a fire suppression measure is performed early and the fire can be quickly extinguished.

Meanwhile, the control unit 120 included in the fire monitoring apparatus 100 can optionally include an application-specific integrated circuit (ASIC), a hardware embedded process, another chipset, a logic circuit, a register, a communication modem, and a data processing device, and the like, known in the art to execute various control logics disclosed below. Also, when the control logic is implemented as software, the control unit 120 can be implemented as a set of program modules. At this time, the program modules can be stored in a memory and executed by the control unit 120. The memory can be internal or external to the control unit 120 and can be connected to the control unit 120 by various well-known means.

In addition, the fire monitoring apparatus 100 can further include a storage unit 130. The storage unit 130 can store data necessary for operation and function of each component of the fire monitoring apparatus 100, data generated in the process of performing the operation or function, or the like. The storage unit 130 is not particularly limited in its kind as long as it is a known information storage means that can record, erase, update and read data. As an example, the information storage means can include random access memory (RAM), flash memory, read-only memory (ROM), electrically erasable programmable read-only memory (EEPROM), registers, and the like. In addition, the storage unit 130 can store program codes in which processes executable by the control unit 120 are defined.

Hereinafter, a fire suppression measure according to the determined fire level will be described in detail.

When the fire level is determined as the first level or the second level, the control unit 120 can be configured to stop the operation of the air conditioning unit 230 provided inside the energy storage system 200.

Specifically, the control unit 120 can be connected to the air conditioning unit 230 provided in the energy storage system 200. Also, the control unit 120 can control the operation of the air conditioning unit 230.

In general, in a normal situation where a fire does not occur in the energy storage system 200, the air conditioning unit 230 is always operated to circulate air inside the energy storage system 200.

However, when the fire level is determined as the first level or the second level, that is, when smoke is detected by one or more smoke sensors 210, smoke or fire can easily spread inside the energy storage system 200 if the air conditioning unit 230 continues to operate.

If the fire level is the first level, there is a possibility of a sensing error of the smoke sensor 210, but the case where smoke is actually detected by only one smoke sensor 210 cannot be ruled out. If smoke is actually detected by one smoke sensor 210, there is a risk that smoke and/or fire can spread to the energy storage system 200 as the air conditioning unit 230 continues to operate. Accordingly, the control unit 120 can be configured to stop operating the air conditioning unit 230 even when the fire level is the first level.

In addition, when the fire level is the second level, since it is very likely that smoke is generated inside the energy storage system 200, the control unit 120 can be configured to stop the operation of the air conditioning unit 230.

Accordingly, the control unit 120 can stop the circulation of the internal air of the energy storage system 200 by stopping the operation of the air conditioning unit 230 when the fire level is determined as the first level or the second level.

Also, when the fire level is determined as the second level, the control unit 120 can be configured to operate the fire extinguishing unit 240 provided inside the energy storage system 200. Here, when the fire extinguishing unit 240 is operated by the control unit 120, a fire extinguishing agent included in the fire extinguishing unit 240 can be injected into the energy storage system 200.

Specifically, the control unit 120 can be connected to the fire extinguishing unit 240 provided inside the energy storage system 200. In addition, the operation of the fire extinguishing unit 240 can be controlled by the control unit 120.

For example, when the fire level is determined as the second level, the control unit 120 can first stop the operation of the air conditioning unit 230 to prevent the smoke and/or fire from circulating within the energy storage system 200. In addition, the control unit 120 can inject a fire extinguishing agent into the energy storage system 200 by operating the fire extinguishing unit 240.

Fires that can occur in the energy storage system 200 can be classified into electrical fires and battery fires.

An electrical fire refers to a fire that can be caused by an electrical cause, such as an overcurrent flowing in the energy storage system 200.

A battery fire refers to a fire that can be caused by internal problems of the battery cell, such as contact between a positive electrode active material and a negative electrode active material due to lithium plating (e.g., an internal short-circuit) and venting of the battery cell due to swelling.

In order to extinguish an electrical fire, it is required to inject a fire extinguishing agent, and in order to extinguish a battery fire, is required to inject water into the battery module. However, it is not possible to accurately distinguish an electrical fire and a battery fire only with the detected smoke.

Accordingly, when the fire level is determined as the second level, the control unit 120 can first operate the fire extinguishing unit 240 to inject a fire extinguishing agent into the energy storage system 200 in order to extinguish the electrical fire.

In addition, when the fire level is determined as the second level, the control unit 120 can be configured to operate the watering unit 300 to introduce the fire extinguishing fluid provided in the watering unit 300 into the pipeline PL.

Specifically, the control unit 120 can be connected to the watering unit 300 to control operation of the watering unit 300.

When the fire level is determined as the second level, the control unit 120 can operate the fire extinguishing unit 240 to inject the fire extinguishing agent into the energy storage system 200, and operate the watering unit 300 to introduce the fire extinguishing fluid into the pipeline PL.

For example, if the fire occurring in the energy storage system 200 is an electrical fire, the temperature of a battery module included in the battery rack may not rise. Therefore, although the fire extinguishing fluid is introduced into the pipeline PL, since the bulb provided in the pipeline PL is not destroyed, the fire extinguishing fluid may not be introduced into the battery module. On the other hand, the electrical fire can be extinguished by injecting the fire extinguishing agent.

As another example, if the fire occurring in the energy storage system 200 is a battery fire, the temperature of the battery module in which the fire has occurred can rise rapidly. In this case, the bulb corresponding to the corresponding battery module can be destroyed, and the fire extinguishing fluid can be introduced into the corresponding battery module through the pipeline PL. Thus, the battery fire can be extinguished by the fire extinguishing fluid.

In this way, when the determined fire level is the second level, the control unit 120 can control the operation of the fire extinguishing unit 240 and the watering unit 300 to extinguish both the electrical fire and the battery fire. Accordingly, fires that can be caused by different causes can be effectively extinguished.

The control unit 120 can be configured to determine the water level of the fire extinguishing fluid provided in the watering unit 300.

Specifically, the control unit 120 can operate the watering unit 300 to introduce the fire extinguishing fluid into the pipeline PL, and then determine the water level of the fire extinguishing fluid stored in the watering unit 300. The watering unit 300 can include a pump to allow for the fire extinguishing fluid to be pumped to the energy storage system 200.

For example, the watering unit 300 can include a water level sensor that measures the water level of the fire extinguishing fluid. The water level sensor is communicatively connected to the control unit 120 and can transmit information about the measured water level to the control unit 120 for each preset period. Also, the control unit 120 can determine the water level of the fire extinguishing fluid based on the water level information received from the water level sensor.

The control unit 120 can be configured to ventilate the energy storage system 200 with an external air by operating the ventilation unit 250 when the determined water level is equal to or lower than a preset critical water level.

Specifically, when the water level of the fire extinguishing fluid is equal to or lower than the critical water level, this can be a case where the fire extinguishing fluid included in the watering unit 300 is introduced into at least one battery module. As described above, even if the fire extinguishing fluid is introduced into the pipeline PL, the fire extinguishing fluid cannot be introduced into the battery module unless the bulb is destroyed. Therefore, when the water level of the fire extinguishing fluid is lowered to the critical water level or less, this means that at least one of the plurality of bulbs included in the pipeline PL is destroyed, and this can indicate that the fire extinguishing fluid is introduced into at least one battery module.

When the fire extinguishing fluid is introduced directly into the battery module to extinguish the battery fire, the inside of the energy storage system 200 can contain a large amount of fire extinguishing agent (e.g., injected by operating the fire extinguishing unit 240), water vapor, and hydrogen (i.e. H²). Accordingly, the control unit 120 can prevent the energy storage system 200 from exploding by operating the ventilation unit 250 to ventilate the energy storage system 200.

The fire monitoring apparatus 100 according to an embodiment of the present disclosure has an advantage of performing an appropriate fire suppression measure for each case in consideration of various conditions in situations where electrical fires, battery fires, and explosions can occur. Therefore, even if a fire occurs in the energy storage system 200, the fire can be extinguished at an early stage, and a larger accident can be prevented from occurring.

Meanwhile, the control unit 120 can be configured to judge that a battery fire has occurred in the energy storage system 200 when the determined water level is less than or equal to a preset critical water level. Conversely, the control unit 120 can be configured to determine that an electrical fire has occurred in the energy storage system 200 when the determined water level exceeds the critical water level.

Specifically, when the determined fire level is the second level, this can be a case where a fire occurs inside the energy storage system 200. However, it is not easy to distinguish whether the cause of a fire is an electrical fire or a battery fire only with the smoke detection signal of the smoke sensor 210.

As described above, in the case of a battery fire, since the temperature of the battery module rises rapidly, the corresponding bulb can be destroyed and the fire extinguishing fluid introduced into the pipeline can be introduced into the battery module. Therefore, in the case of a battery fire, the water level of the fire extinguishing fluid included in the watering unit 300 can be lowered to the critical water level or below.

On the other hand, in the case of an electrical fire, since the bulb is not destroyed, even if smoke is detected, the water level of the fire extinguishing fluid is not lowered to the critical water level or below.

That is, after the control unit 120 operates the fire extinguishing unit 240 and the watering unit 300, the cause of the fire can be classified into an electrical fire or a battery fire according to the result of comparing the water level of the fire extinguishing fluid with the preset critical water level.

Accordingly, the fire monitoring apparatus 100 according to an embodiment of the present disclosure can not only extinguish a fire occurring in the energy storage system 200 at an early stage, but also analyze the cause of the fire in detail. In addition, the fire monitoring apparatus 100 has an advantage of providing information necessary for fire cause analysis by notifying the user or the outside of a specific fire cause.

The control unit 120 can be configured to receive the measured gas concentration from the gas sensor 220 provided in the energy storage system 200.

Specifically, the control unit 120 can be communicatively connected to the gas sensor 220 provided in the energy storage system 200. Also, the control unit 120 can receive information about gas concentration measured by the gas sensor 220.

For example, the gas measured by the gas sensor 220 can be a combustible gas or an explosive gas. More specifically, the gas measured by the gas sensor 220 can be H². That is, the gas sensor 220 can be configured to measure the concentration of H².

The control unit 120 can be configured to stop the operation of the air conditioning unit 230 provided inside the energy storage system 200 when the measured gas concentration is equal to or greater than a preset critical concentration.

For example, since there is a risk of explosion of the energy storage system 200 when the concentration of the gas exceeds the critical concentration, the control unit 120 can stop the operation of the air conditioning unit 230 for circulating an internal air of the energy storage system 200.

Also, the control unit 120 can be configured to operate the ventilation unit 250 to ventilate the energy storage system 200 with an external air. That is, the control unit 120 can operate the ventilation unit 250 to discharge the gas contained in the sealed inside of the energy storage system 200 to the outside. Accordingly, as the concentration of the gas included in the energy storage system 200 gradually decreases, the risk of explosion of the energy storage system 200 can be reduced.

The fire monitoring apparatus 100 according to an embodiment of the present disclosure can perform a fire suppression measure in consideration of the concentration of gas included in the energy storage system 200 as well as the smoke generated inside the energy storage system 200.

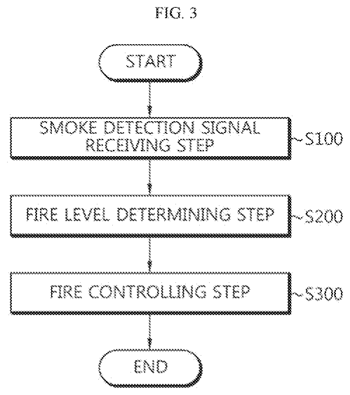

FIG. 3 is a diagram schematically showing a fire monitoring method according to still another embodiment of the present disclosure.

Preferably, each step of the fire monitoring method can be performed by the fire monitoring apparatus 100. Hereinafter, for convenience of explanation, the content overlapping with the previously described content will be omitted or briefly described.

The fire monitoring method can be a method for monitoring a fire in the energy storage system 200 equipped with a plurality of battery modules.

Referring to FIG. 3, the fire monitoring method can include a smoke detection signal receiving step (S100), a fire level determining step (S200), and a fire controlling step (S300).

The smoke detection signal receiving step (S100) is a step of receiving a smoke detection signal from the smoke sensor 210 provided inside the energy storage system 200, and can be performed by the fire level determination unit 110.

For example, the fire level determination unit 110 can be connected to a plurality of smoke sensors 210 and receive a smoke detection signal from each smoke sensor 210.

The fire level determining step (S200) is a step of determining a fire level according to the number of smoke sensors 210 that detects smoke when smoke is detected, and can be performed by the fire level determination unit 110.

For example, when receiving a smoke detection signal from one smoke sensor 210, the fire level determination unit 110 can determine the fire level as the first level. As another example, the fire level determination unit 110 can determine the fire level as the second level when receiving a smoke detection signal from the plurality of smoke sensors 210. If the fire level determination unit 110 does not receive the smoke detection signal, the fire level can be determined as the zero level or NULL.

The fire controlling step (S300) is a step of controlling the operation of at least one of the air conditioning unit 230, the fire extinguishing unit 240, the watering unit 300, and the ventilation unit 250 for the energy storage system 200 as a fire suppression measure corresponding to the determined fire level, and can be performed by the control unit 120.

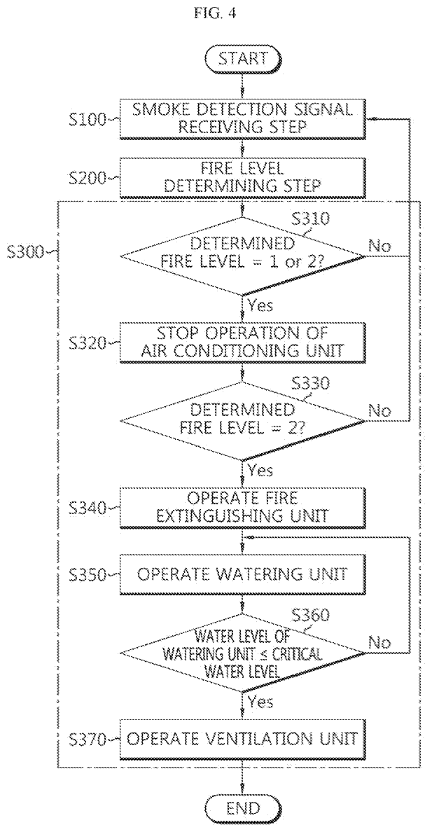

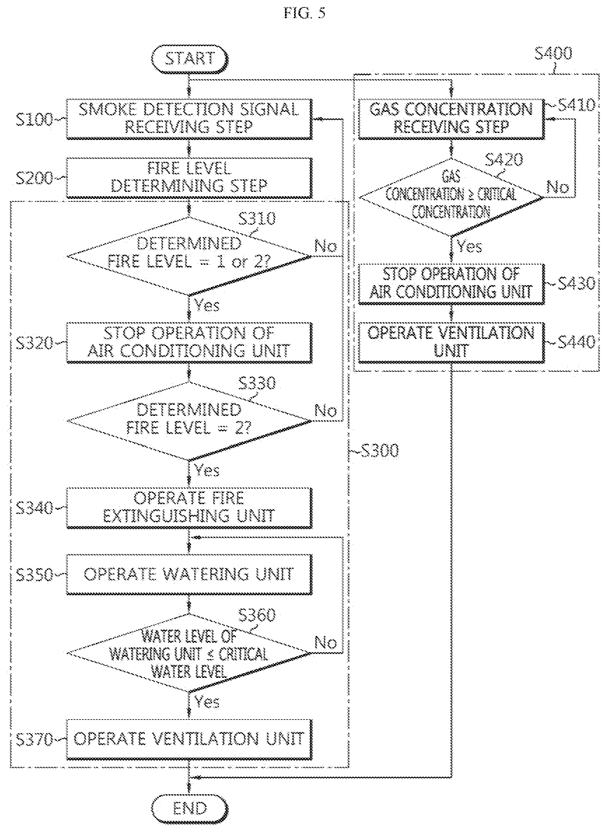

The fire controlling step (S300) will be described in detail with reference to FIG. 4. FIG. 4 is a diagram showing the fire monitoring method of FIG. 3 in more detail. Referring to FIG. 4, the fire controlling step (S300) can include steps S310 to S370. In the step S310, it can be judged whether the fire level determined in the fire level determining step (S200) is the first level or the second level. If the determined fire level is the first level or the second level, the step S320 can be performed, and otherwise, the smoke detection signal receiving step (S100) can be performed.

In the step S320, the control unit 120 can stop the operation of the air conditioning unit 230 provided in the energy storage system 200. Accordingly, the circulation of the internal air of the energy storage system 200 can be stopped.

In the step S330, it can be judged whether the fire level determined in the fire level determining step (S200) is the second level. If the determined fire level is the second level, the step S330 can be performed, and otherwise, the smoke detection signal receiving step (S100) can be performed.

In the step S340, the control unit 120 can operate the fire extinguishing unit 240. Specifically, the control unit 120 can operate the fire extinguishing unit 240 to extinguish an electrical fire that can occur at the second fire level. In this case, the fire extinguishing agent stored in the fire extinguishing unit 240 can be injected into the energy storage system 200.

In the step S350, the control unit 120 can operate the watering unit 300. Specifically, the control unit 120 can operate the watering unit 300 to extinguish a battery fire that can occur at the second fire level. In this case, the fire extinguishing fluid stored in the watering unit 300 can be introduced into the pipeline PL.

In the step S360, it can be judged whether the water level of the watering unit 300 (e.g., the water level of the fire extinguishing fluid included in the watering unit 300) is equal to or less than the critical water level. If the water level of the watering unit 300 is equal to or less than the critical water level, the step S370 can be performed, and otherwise, the step S350 can be performed.

Here, if the water level of the watering unit 300 is equal to or lower than the critical water level, this means that at least one of the plurality of bulbs included in the pipeline PL is destroyed. Also, since the fire extinguishing fluid is introduced into the battery module through the destroyed bulb, this means that the water level of the watering unit 300 is lowered to the critical water level or below.

On the other hand, in step S360, if the water level of the watering unit 300 is not lowered to the critical water level or below even though a predetermined time has elapsed after the step S350 is performed, this means that all of the plurality of bulbs provided in the pipeline PL are not destroyed. In this case, the smoke detected by the plurality of smoke sensors 110 is determined as smoke caused by an electrical fire, and the electrical fire can be extinguished by operating the fire extinguishing unit 240 in the step S340. Therefore, since the bulb is not destroyed, the water level of the watering unit 300 may not be lowered to the critical water level or below. Although not shown in FIGS. 4 and 5, the control unit 120 can perform the starting step again if the water level of the watering unit 300 is not lowered to the critical water level or below until a predetermined time elapses after the step S350 is first performed.

If the water level of the watering unit 300 is less than or equal to the critical water level or below, step S370 is performed in which the control unit 120 can operate the ventilation unit 250. Specifically, when the battery fire is extinguished by introducing the fire extinguishing fluid into the battery module, the control unit 120 can operate the ventilation unit 250 to process the fire extinguishing agent, water vapor, and H² included in the energy storage system 200. In this case, an external air is introduced into the energy storage system 200 and the energy storage system 200 can be ventilated. Therefore, since gases contained in the energy storage system 200 can escape, the possibility of explosion of the energy storage system 200 can be reduced.

The fire monitoring method according to an embodiment of the present disclosure can appropriately control the air conditioning unit 230, the fire extinguishing unit 240, the watering unit 300, and the ventilation unit 250 based on the number of sensors that detect smoke, and perform a fire suppression measure. Therefore, the fire monitoring method has an advantage of distinguishing the case where the smoke sensor 210 malfunctions and taking an appropriate fire suppression measure to correspond to the type of fire (e.g., electrical fire or battery fire) even if a fire occurs.

FIG. 5 is a diagram schematically showing a fire monitoring method according to still another embodiment of the present disclosure.

Referring to FIG. 5, the fire monitoring method can further include a ventilation controlling step (S400).

The ventilation controlling step (S400) is a step that can be performed in parallel with the smoke detection signal receiving step (S100).

The ventilation controlling step (S400) is a step of receiving the measured gas concentration from the gas sensor 220 provided in the energy storage system 200, and controlling the operation of the air conditioning unit 230 and the ventilation unit 250 according to the result of comparing the measured gas concentration with a preset critical concentration, and can be performed by the control unit 120.

Specifically, in the step S410, the control unit 120 can receive information on gas concentration from the gas sensor 220 provided in the energy storage system 200.

In the step S420, it can be judged whether the gas concentration is equal to or greater than the preset critical concentration. If the gas concentration is equal to or greater than the preset critical concentration, the step S430 can be performed, and otherwise, the step S410 can be performed.

In the step S430, the control unit 120 can stop the operation of the air conditioning unit 230 provided in the energy storage system 200. Accordingly, the circulation of the internal air of the energy storage system 200 can be stopped.

In the step S440, the control unit 120 can operate the ventilation unit 250. Specifically, the control unit 120 can operate the ventilation unit 250 to prevent an explosion of the energy storage system 200 when a gas concentration equal to or greater than the critical concentration is included inside the energy storage system 200.

For example, the gas whose concentration is measured by the gas sensor 220 can be a combustible gas or an explosive gas. More specifically, the gas can be H².

If H² equal to or greater than the critical concentration is distributed in the closed energy storage system 200, an explosion can occur when H² comes in contact with sparks or the like. Accordingly, the control unit 120 can significantly reduce the possibility of explosion of the energy storage system 200 by operating the ventilation unit 250 to discharge the gas to the outside of the energy storage system 200 when the gas concentration is equal to or greater than the critical concentration.

The embodiments of the present disclosure described above may not be implemented only through an apparatus and method, but can be implemented through a program that realizes a function corresponding to the configuration of the embodiments of the present disclosure or a recording medium on which the program is recorded. The program or recording medium can be easily implemented by those skilled in the art from the above description of the embodiments.

Various embodiments described herein may be implemented in a computer-readable medium using, for example, software, hardware, or some combination thereof. For example, the embodiments described herein may be implemented within one or more of Application Specific Integrated Circuits (ASICs). Digital Signal Processors (DSPs). Digital Signal Processing Devices (DSPDs), Programmable Logic Devices (PLDs). Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions may be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In addition, since the present disclosure described above can be substituted, modified and changed in various ways by those skilled in the art without departing from the technical idea of the present disclosure, the present disclosure is not limited by the embodiments described above and the accompanying drawings, and all or some of the embodiments can be selectively combined to enable various modifications.

### Explanation of Reference Signs

100: fire monitoring apparatus
110: fire level determination unit
120: control unit
130: storage unit
200: energy storage system
210: smoke sensor
220: gas sensor
230: air conditioning unit
240: fire extinguishing unit
250: ventilation unit
300: watering unit

1. A fire monitoring apparatus for monitoring a fire in an energy storage system equipped with a plurality of battery modules, the fire monitoring apparatus comprising:
a fire level determination unit configured to receive a smoke detection signal from a plurality of smoke sensors provided inside the energy storage system and determine a fire level according to a number the plurality of smoke sensors that detect the smoke; and
a control unit configured to control an operation of at least one of an air conditioning unit, a fire extinguishing unit, a watering unit and a ventilation unit of the energy storage system as a fire suppression measure corresponding to the determined fire level.

2. The fire monitoring apparatus according to claim 1, wherein the fire level determination unit is configured to:
determine the fire level as a first level when the smoke is detected in only one of the plurality of smoke sensors, and
determine the fire level as a second level when the smoke is detected in several smoke sensors among the plurality of smoke sensors.

3. The fire monitoring apparatus according to claim 2,
wherein the control unit is configured to stop the operation of the air conditioning unit provided inside the energy storage system when the fire level is determined as the first level or the second level.

4. The fire monitoring apparatus according to claim 2,
wherein when the fire level is determined as the second level, the control unit is configured to operate the fire extinguishing unit provided inside the energy storage system, so that a fire extinguishing agent contained inside the fire extinguishing unit is injected into the energy storage system.

5. The fire monitoring apparatus according to claim 2,
wherein the watering unit is configured to be connected to each battery module included in the energy storage system through a pipeline equipped with a respective bulb among a plurality of bulbs that is capable of being destroyed according to a temperature of the corresponding battery module to allow water to flow from the watering unit to the energy storage system, and
wherein the control unit is configured to introduce the fire extinguishing fluid provided in the watering unit into the pipeline by operating the watering unit, when the fire level is determined as the second level.

6. The fire monitoring apparatus according to claim 5,
wherein the fire extinguishing fluid is introduced into the pipeline by the watering unit and introduced into a respective one of the battery modules at which the respective bulb is destroyed due to an increase in temperature of the respective battery module.

7. The fire monitoring apparatus according to claim 5,
wherein the control unit is configured to determine a water level of the fire extinguishing fluid provided in the watering unit, and operate the ventilation unit to ventilate the energy storage system with an external air, in response to the determined water level being equal to or lower than a preset critical water level.

8. The fire monitoring apparatus according to claim 5,
wherein the control unit is configured to:
determine a water level of the fire extinguishing fluid provided in the watering unit,
determine that a battery fire occurs in the energy storage system when the determined water level is equal to or lower than a preset critical water level, and
determined that an electrical fire occurs in the energy storage system when the determined water level exceeds the critical water level.

9. The fire monitoring apparatus according to claim 1,
wherein the control unit is configured to receive a measured gas concentration from a gas sensor provided in the energy storage system, stop the operation of the air conditioning unit provided inside the energy storage system when the measured gas concentration is equal to or greater than a preset critical concentration, and operate the ventilation unit to ventilate the energy storage system with an external air.

10. A fire monitoring system, comprising:
the fire monitoring apparatus according to claim 1; and
an energy storage system including:
the air conditioning unit, the fire extinguishing unit, the watering unit and the ventilation unit.

11. A fire monitoring method for monitoring a fire in an energy storage system equipped with a plurality of battery modules, the fire monitoring method comprising:
a smoke detection signal receiving step of receiving a smoke detection signal from at least one smoke sensor among a plurality of smoke sensors provided inside the energy storage system;
a fire level determining step of determining a fire level according to a number of smoke sensors that detect the smoke, when the smoke is detected; and
a fire controlling step of controlling an operation of at least one of an air conditioning unit, a fire extinguishing unit, a watering unit and a ventilation unit of the energy storage system as a fire suppression measure corresponding to the determined fire level.

12. The fire monitoring apparatus according to claim 11, further comprising:
in parallel to the smoke detection signal receiving step, a ventilation controlling step of receiving a measured gas concentration from a gas sensor provided in the energy storage system, and controlling the operation of the air conditioning unit and the ventilation unit according to a result of comparing the measured gas concentration with a preset critical concentration.

13. A fire monitoring system, comprising:
an energy storage system including:
a battery module;
a plurality of smoke sensors configured to detect smoke generated inside the energy storage system;
an air conditioning unit configured to circulate air inside the energy storage system;
a watering unit configured to store a fire extinguishing fluid; and
a ventilation unit configured to introduce external air into the energy storage system; and
a fire monitoring apparatus configured to:
receive a smoke detection signal from the plurality of smoke sensors,
determine a fire level according to a number the plurality of smoke sensors of that detect the smoke, and
control an operation of at least one of the air conditioning unit, the watering unit and the ventilation unit as a fire suppression measure based on the determined fire level.

14. The fire monitoring system of claim 13, wherein the fire monitoring apparatus is configured to:
determine the fire level as a first level when the smoke is detected in only one of the plurality of smoke sensors, and
determine the fire level as a second level when the smoke is detected in several smoke sensors among the plurality of smoke sensors.

15. The fire monitoring system of claim 14, wherein in response to the fire level being the first level, the fire monitoring apparatus is configured to stop operation of the air condition unit, and
wherein in response to the first level being the second level, the fire monitoring apparatus is configured to operate the watering unit.

16. The fire monitoring system of claim 15, wherein in response to operating the watering unit, the fire monitoring apparatus is configured to determine a water level of the water unit, and
wherein in response to the water level being equal to or less than a critical water level, the fire monitoring apparatus is configured to operate the ventilation unit.

17. The fire monitoring system of claim 15, further comprising:
a pipeline connecting the watering unit to the battery module; and
a bulb provided in the pipeline adjacent to the battery module, the bulb being configured to break in response to a temperature of the battery module reaching a predetermined temperature to allow water to flow from the pipeline to the battery module.

18. The fire monitoring system of claim 15, wherein the battery module is a first battery module among a plurality of battery modules of the energy storage system,
wherein the fire monitoring system further comprises:
a pipeline connecting the watering unit to the plurality of battery modules; and
a plurality of bulbs, each bulb provided in the pipeline adjacent to a respective one of the plurality of battery modules, and
wherein each bulb is configured to break in response to a temperature of the respective battery module reaching a predetermined temperature to allow water to flow from the pipeline to the respective battery module.

19. The fire monitoring system of claim 15, wherein the energy storage system further includes a gas sensor configured to measure a gas concentration in the energy storage system.

20. The fire monitoring system of claim 19, wherein the fire monitoring apparatus is further configured to:
receive a measured gas concentration from the gas sensor, and
in response to the measured gas concentration being equal to or greater than a preset critical concentration, stop the operation of the air conditioning unit and operate the ventilation unit to ventilate the energy storage system with an external air.
